(19) United States
(12) Patent Application Publication
(10) Pub. No.: US 2024/0218485 A1
(43) Pub. Date: Jul. 4, 2024

(54) STRIP OR SHEET OF ALUMINIUM ALLOY FOR MANUFACTURING BRAZED HEAT EXCHANGERS

(71) Applicant: CONSTELLIUM NEUF-BRISACH, Biesheim (FR)

(72) Inventors: Lionel PEGUET, Quaix en Chartreuse (FR); Armelle DANIELOU, Les Echelles (FR)

(21) Appl. No.: 18/558,222

(22) PCT Filed: Apr. 21, 2022
(86) PCT No.: PCT/FR2022/050750

§ 371 Date: Oct. 31, 2023

(30) Foreign Application Priority Data
May 3, 2021 (FR) FR2104619

(51) Int. Cl. C22C 21/02; B23K 1/00; C22F 1/043

(52) U.S. Cl. CPC C22C 21/02; B23K 1/0012; C22F 1/043

(57) ABSTRACT

A strip or sheet intended for the manufacture of brazed heat exchangers, having a core layer made of an aluminum alloy with the following composition (% by weight): Si: more than 0.25% and less than 0.70%; Fe: less than 0.25% and at least 0.08%; Cu: more than 0.60% and less than 1.10%; Mn: more than 1.40% and less than 2.00%; Ti: less than 0.15% and more than 0.05%; Mg: less than 0.05%; Zr: less than 0.01%; Cr: less than 0.01%; Zn: less than 0.20%; impurities: less than 0.05% each and less than 0.15% in total; remainder aluminum.

### TECHNICAL FIELD

The invention relates to thin strips or sheets (with a thickness generally comprised from 0.05 to 3 mm, preferably from 0.15 to 2.5 mm) made of an aluminum-manganese core alloy (3xxx series according to the nomenclature of the Aluminum Association), optionally plated over one or two face(s) with a covering alloy, most often an aluminum-silicon brazing alloy (4xxx series according to the nomenclature of the Aluminum Association) and/or an interlayer alloy, placed between the core and the optional brazing alloy, made of an aluminum-manganese alloy (3xxx series according to the nomenclature of the Aluminum Association). In particular, these strips or sheets are intended for the manufacture of elements, such as tubes, manifolds and plates, of heat exchangers assembled by brazing, in particular for motor vehicles, such as engine cooling radiators, evaporators, heater radiators and charge air coolers, manifolds, battery coolers in electric vehicles, as well as in air-conditioning systems. In particular, these exchangers are found in engine cooling and air-conditioning systems for motor vehicle passenger compartments. For example, techniques for brazing aluminum alloys are described in the article by J. C. Kucza, A. Uhry and J. C. Goussain “Le brasage fort de l'aluminium et ses alliages”, published in Soudage et Techniques Connexes, November-December 1991, p. 18-29. In particular, the strips or sheets according to the invention may be used in brazing techniques with a non-corrosive flux of the NOCOLOK® or CAB (controlled atmosphere brazing) type.

### PRIOR ART

In particular, the properties required for strips or sheets made of an aluminum alloy used for the manufacture of brazed exchangers include a sufficient formability for an easyforming of the tubes, manifold fins and plates, before brazing, a good brazability, a high mechanical strength after brazing, so as to use the smallest possible thicknesses, a good resistance to fatigue stress in service, and a good resistance to corrosion after brazing. Of course, it is important for the selected alloy to be easy to cast and to roll, and for the manufacturing cost of the strips or sheets to be compatible with the requirements of the automotive industry.

In order to promote the thickness reduction of the tubes for heat exchangers (such as radiators), it is particularly interesting to increase the mechanical properties of the material after brazing (in particular the maximum load (Rm) of the tensile curve obtained according to the standard ISO 6892-1 (“Ultimate Tensile Strength” or “UTS”), which is a key factor in fatigue resistance), without reducing corrosion resistance or brazability.

Solutions have already been proposed in this direction. For example, mention may be made of the following patent applications, disclosing the compositions hereinafter:
WO2020/178507: 0.1-0.3% Si; <0.2% Fe; 0.75-1.05% Cu; 1.2-1.7% Mn; <0.03% Mg; <0.15% Ti; <0.1% Zn;
EP1183151: 0.4-0.8% Si; <0.4% Fe; 0.5-2% Cu; 0.5-1.5% Mn;
EP2017032: 0.3-1.2% Si; 0.05-0.4% Fe; 0.3-1.2% Cu; 0.3-1.8% Mn; 0.05-0.6% Mg; <0.3% Ti; <0.3% Zr; <0.3% Cr.

Yet, the proposed solutions do not necessarily allow solving the good trade-off between a good mechanical strength after brazing, a good resistance to corrosion and a good brazability.

Given the increasing market demand, there is still a need for a new core alloy having an improved mechanical strength compared to existing alloys, without degradation of the corrosion resistance or brazability. Such a core alloy could allow meeting the still present demand for reducing the thickness of products.

### DISCLOSURE OF THE INVENTION

Surprisingly, the Applicant has determined a composition range allowing improving the mechanical strength without degrading the corrosion resistance or the brazability.

For example, the target according to the present invention may be to reach a tensile strength Rm higher than 140 MPa, preferably higher than 145 MPa, preferably higher than 150 MPa, preferably higher than 160 MPa for industrial bands or sheets after brazing.

As demonstrated in the examples, the present invention further has the unexpected advantage of improving the resistance to corrosion, for example corrosion in the SWAAT test.

Thus, an object of the invention is a strip or sheet, intended for the manufacture of brazed heat exchangers, having a core layer, optionally a covering layer on one or two face(s) of the core layer and optionally an interlayer on one or two face(s) of the core layer placed between the core layer and the optional covering layer, the core layer being made of an aluminum alloy with the following composition (% by weight):
Si: more than 0.25%, preferably more than 0.30%, preferably more than 0.35%, preferably more than 0.40%; and less than 0.70%, preferably less than 0.65%, preferably less than 0.60%, preferably less than 0.55%;
Fe: less than 0.25%, preferably less than 0.20%; and at least 0.08%, preferably more than 0.10%;
Cu: more than 0.60%, preferably more than 0.70%, preferably more than 0.80%, preferably more than 0.85%; and less than 1.10%, preferably less than 1.00%, preferably less than 0.95%;
Mn: more than 1.40%, preferably more than 1.50%; and less than 2.00%, preferably less than 1.80%, preferably less than 1.65%;
Ti: less than 0.15%, preferably less than 0.12%, preferably less than 0.10%; and more than 0.05%;
Mg: less than 0.05%, preferably less than 0.02%, preferably less than 0.01%, preferably less than 0.001%;
Zr: less than 0.01%, preferably less than 0.005%;
Cr: less than 0.01%, preferably less than 0.005%;
Zn: less than 0.20%, preferably less than 0.10%, preferably less than 0.05%, preferably less than 0.01%;
impurities: less than 0.05% each and less than 0.15% in total;
remainder aluminum.

Another object of the invention is a method for manufacturing a strip or sheet according to the present invention, comprising the successive steps of:
casting a plate made of a core alloy;
optionally homogenizing the plate at 550 to 630° C., preferably at 580 to 630° C. for 1 to 24 hours;
optionally plating with a covering aluminum alloy over one or two face(s) of the core layer and optionally an interlayer aluminum alloy over one or two face(s) of the core layer;
preheating to a temperature from 450 to 550° C., preferably with maintenance at the maximum temperature for less than 30 hours, preferably for less than 20 hours, preferably for less than 12 hours, more preferably for less than 3 hours;
hot rolling the optionally homogenized and optionally plated plate at a temperature from 420 to 530° C. up to a thickness of 2 to 6 mm,
cold rolling to the desired thickness, the thickness of the strip or sheet after cold rolling preferably being 0.15 to 3 mm, and
annealing at a temperature from 240 to 450° C., preferably from 240 to 400° C., preferably from 280 to 370° C., with maintenance at the maximum temperature for 10 minutes to 15 hours, preferably for 20 minutes to 3 hours.

Another object of the invention is a heat exchanger made at least partially from a strip or sheet according to the present invention.

Another object of the invention is the use of a strip or sheet according to the present invention, for the manufacture of a heat exchanger, said strip or sheet having an improved mechanical strength without degradation of the corrosion resistance or of the brazability.

### FIGURES

FIG. 1 is a diagram describing the puncture analysis during the SWAAT corrosion resistance test of the examples.

### DETAILED DESCRIPTION OF THE INVENTION

In the description and in the claims, unless stated otherwise:
the designation of the aluminum alloys in accordance with the nomenclature of The Aluminum Association;
the contents of chemical elements are designated in weight percentages.

### Core Aluminum Alloy

The strip or sheet according to the present invention is intended for the manufacture of brazed heat exchangers, and has a core layer, optionally a covering layer on one or two face(s) of the core layer and optionally an interlayer over one or two face(s) of the core layer placed between the core layer and the optional covering layer, the core layer being made of an aluminum alloy with the following composition (% by weight):
Si: more than 0.25%, preferably more than 0.30%, preferably more than 0.35%, preferably more than 0.40%; and less than 0.70%, preferably less than 0.65%, preferably less than 0.60%, preferably less than 0.55%;
Fe: less than 0.25%, preferably less than 0.20%; and at least 0.08%, preferably more than 0.10%;
Cu: more than 0.60%, preferably more than 0.70%, preferably more than 0.80%, preferably more than 0.85%; and less than 1.10%, preferably less than 1.00%, preferably less than 0.95%;
Mn: more than 1.40%, preferably more than 1.50%; and less than 2.00%, preferably less than 1.80%, preferably less than 1.65%;
Ti: less than 0.15%, preferably less than 0.12%, preferably less than 0.10%; and more than 0.05%;
Mg: less than 0.05%, preferably less than 0.02%, preferably less than 0.01%, preferably less than 0.001%;
Zr: less than 0.01%, preferably less than 0.005%;
Cr: less than 0.01%, preferably less than 0.005%;
Zn: less than 0.20%, preferably less than 0.10%, preferably less than 0.05%, preferably less than 0.01%;
impurities: less than 0.05% each and less than 0.15% in total;
remainder aluminum.

The composition limits of the core alloy may be justified as follows.

A minimum silicon content of 0.10% allows avoiding the use of a pure base, the cost of which is high. It has been observed that Si contents greater than 0.25% allow improving the corrosion resistance, for example in the SWAAT test. Hence, the silicon content is preferably greater than 0.25%, preferably greater than 0.30%, preferably greater than 0.35%, preferably greater than 0.40%.

An excessively high silicon content can reduce the solidus temperature of the core and jeopardize the brazing. It is preferable to limit the silicon to less than 0.70%, preferably less than 0.65%, preferably less than 0.60%, preferably less than 0.55%.

An iron content limited to less than 0.25%, preferably less than 0.20%, is also favorable to the resistance to corrosion and to the formability, in particular by reducing the fraction of coarse precipitates containing iron. However, it is not necessary to step down to very low contents, for example less than 0.08%, which would lead to high cost prices. Consequently, the iron content is greater than or equal to 0.08%, preferably more than 0.10%.

Copper is a hardening element which contributes to the mechanical resistance, but beyond 1.1%, the risk of forming cracks during casting is higher. Coarse intermetallic compounds may also form during casting which affect the homogeneity of the metal and could form corrosion start sites. To obtain a high mechanical strength, the copper content is greater than 0.60%, preferably greater than 0.70%, preferably greater than 0.80%, preferably greater than 0.85%. Preferably, the copper content is less than 1.10%, preferably less than 1.00%, preferably less than 0.95%.

Manganese contributes to the mechanical strength by solid solution and by formation of Al—Mn—Si dispersoids. To obtain a significant hardening, the manganese content is preferably greater than 1.40%, preferably greater than 1.50%. To avoid forming a large number of coarse phases during casting, which could reduce formability, it is recommended to limit the Mn content to less than 2.00%, preferably less than 1.80%, preferably less than 1.65%.

A limited addition of zinc may have a beneficial effect on the resistance to corrosion, by modifying the electrochemical mechanisms, in particular for the alloys with the highest copper content. However, it should remain below 0.20% to avoid an excessive susceptibility to generalized corrosion of the core. Preferably, the Zn content is limited to less than 0.10%, preferably less than 0.05%, preferably less than 0.01%.

Magnesium provides a significant gain in mechanical strength. However, in the case of brazing in a flux controlled atmosphere furnace (CAB), it is preferred to limit its content to less than 0.2%. According to the present invention, the magnesium content is less than 0.05%, preferably less than 0.02%, preferably less than 0.01%, preferably less than 0.001%.

Titanium allows controlling the size of the grains during casting. Its content is less than 0.15%, preferably less than 0.12%, preferably less than 0.10%. Preferably, the Ti content is greater than 0.05%.

Zirconium and chromium may optionally be added. However, they are preferably absent, or present at a content corresponding to the impurities, i.e. less than 0.01%, preferably less than 0.005% each.

### Covering Aluminum Alloy

The strips or sheets according to the present invention have a thickness generally comprised from 0.05 to 3 mm, preferably from 0.15 to 2.5 mm, according to the type of manufactured part, and may be plated, over one or two face(s) of the core layer and/or over a free face of the optional interlayer, with a covering alloy, which may be either a brazing alloy, or an alloy acting as a sacrificial anode to protect the part from corrosion, such as an alloy containing zinc, for example of the 7xxx series, preferably comprising from 0.70 to less than 2.50%, preferably from 0.70 to less than 1.30%, preferably from 0.70 to less than 1.00% Zn, or for example of the 3xxx series, preferably comprising from 0.50 to 1.60%, preferably from 0.90 to 1.20% Zn. For example, the alloy of the 7xxx series may be the AA7072 alloy. The free face of the optional interlayer corresponds to the face of the interlayer which is not in contact with the core layer. It should be noted that a brazing layer may be plated over one or two face(s) of a core layer and/or over the free face of an interlayer, while the sacrificial anode may be plated preferably only on one or two face(s) of a core layer, without any interlayer between the core layer and the sacrificial anode.

According to one variant, a covering alloy of the sacrificial anode type could be, according to the present invention, a 7xxx series alloy, preferably having the following composition, in weight percentages: less than 0.50% Si; less than 0.50% Fe; less than 0.25% Cu; less than 0.30% Mn; less than 0.20%, preferably less than 0.15% Mg; from 0.70 to 5.00%, preferably from 0.70 to less than 2.50%, preferably from 0.70 to less than 1.30%, preferably from 0.70 to less than 1.00% Zn; less than 0.15% Ti; other elements less than 0.05% each and less than 0.15% in total; remainder aluminum.

For example, the composition AA7072 is an aluminum alloy which may be suitable as a sacrificial anode according to the present invention. Its composition is, in weight percentages: less than 0.05% Si; less than 0.05% Fe; less than 0.10% Cu; less than 0.10% Mn; less than 0.10% Mg; from 0.80 to 1.30% Zn; other elements less than 0.05% each and less than 0.15% in total; the remainder being aluminum.

According to one variant, the composition AA7072 preferably comprises less than 1.00% Zn.

According to another variant, a covering alloy of the sacrificial anode type could be, according to the present invention, a 3xxx series alloy, preferably having the following composition, in weight percentages: from 0.10 to 0.35% Si; less than 0.70% Fe; less than 0.20% Cu; from 0.70 to 2.00%, preferably from 0.90 to 1.30% Mn; from 0.50 to 1.60%, preferably from 0.90 to 1.20% Zn; less than 0.15% Ti; other elements less than 0.05% each and less than 0.15% in total; remainder aluminum.

Preferred values of each of the elements of the alloys of the 3xxx series or of the 7xxx series, which could be suitable as a sacrificial anode according to the present invention, are reported for example in Table 1 hereinafter (columns 3xxx-1, 7xxx-1 and 7xxx-2), in weight percentages.

TABLE 1

| | 3xxx-1 | 7xxx-1 | 7xxx-2 |
|---|---|---|---|
| Si | 0.10-0.35% | 0.05-0.30% | 0.15-0.40% |
| Fe | <0.70% | 0.25-0.45% | <0.40% |
| Cu | <0.20% | <0.15% | <0.15% |
| Mn | 0.7-1.30% | <0.15% | <0.10% |
| Mg | <0.05% | <0.05% | <0.10% |
| Cr | <0.05% | <0.05% | <0.05% |
| Ni | <0.05% | <0.05% | <0.05% |
| Zn | 0.9-1.55% | 0.80-1.30% Pref. | 3.50-4.50% |
| | | 0.80 to <1% | |
| Ti | <0.10 | <0.10% | <0.10% |
| | Pref. <0.05% | Pref. <0.05% | Pref. <0.05% |
| Zr | <0.05% | <0.05% | <0.05% |

Preferably, the brazing alloy is a 4xxx series alloy, preferably comprising less than 0.20%, preferably less than 0.10%, preferably less than 0.05%, preferably less than 0.02% Zn, with a sufficiently low liquidus temperature compared to the solidus of the core alloy to have a sufficient temperature range for brazing, an acceptable mechanical strength and a good wettability. These alloys may contain addition elements, for example strontium, preferably according to a mass fraction of less than 0.05%.

According to one variant, the brazing alloy of the present invention comprises Y, Sn and/or Bi. In particular, this variant has an advantage for flux-less brazing.

Preferably, the brazing alloy comprises:
from 0.01 to 0.10%, preferably from 0.015 to 0.08%, preferably from 0.02 to 0.065% Y;
from 0.01 to 0.10%, preferably from 0.015 to 0.08%, preferably from 0.02 to 0.065% Sn; and/or
at most 0.04%, preferably at most 0.03%, preferably at most 0.02% Bi according to a first variant; or at most 0.15%, preferably at most 0.12%, and preferably at least 0.05% Bi according to a second variant.

Preferably, the strip or sheet according to the present invention is plated, over one or two face(s) of the core layer and/or over a free face of an optional interlayer with a brazing aluminum alloy, preferably a 4xxx series alloy comprising from 4.00 to 13.00% by weight of Si, less than 1.00% by weight of Fe, and preferably less than 0.20%, preferably less than 0.10%, preferably less than 0.05%, preferably less than 0.02% Zn.

Preferably, the brazing aluminum alloy of the 4xxx series comprises (% by weight):
Si: from 5.00 to 13.00%, preferably from 6.00 to 11.00%, preferably from 7.50 to 10.50%;
Fe: less than 0.60%, preferably less than 0.50%, preferably less than 0.30%;
Cu: less than 0.40%, preferably less than 0.10%, preferably less than 0.05%;
Mn: less than 0.20%, preferably less than 0.10%, preferably less than 0.05%;
Mg: according to a first variant less than 0.20%, preferably less than 0.10%, preferably less than 0.05%; or according to a second variant from 0.50 to 2.50%, preferably from 1.00 to 2.00%;
Zn: less than 0.20%, preferably less than 0.10%, preferably less than 0.05%, preferably less than 0.02%;
Ti: less than 0.30%, preferably less than 0.10%, preferably less than 0.05%;
optionally Bi, Y, Sr and/or Sn;
other elements: less than 0.05% each and less than 0.15% in total;
remainder aluminum.

For example, the AA4045 composition is an aluminum alloy which could be suitable as a brazing alloy according to the present invention. Its composition is, in weight percentages: from 9.0 to 11.0% Si, less than 0.80% Fe, less than 0.30% Cu, less than 0.05% Mn, less than 0.05% Mg, less than 0.10% Zn, less than 0.20% Ti, other elements less than 0.05% each and less than 0.15% in total, the remainder being aluminum.

For example, the previous composition preferably comprises less than 0.60% Fe.

For example, the previous composition preferably comprises less than 0.10% Cu.

For example, the AA4343 composition is an aluminum alloy which could be suitable as a brazing alloy according to the present invention. Its composition is, in weight percentages: from 6.80 to 8.20% Si, less than 0.80% Fe, less than 0.25% Cu, less than 0.10% Mn, less than 0.05% Mg, other elements less than 0.05% each and less than 0.15% in total, the remainder being aluminum.

For example, the previous composition preferably comprises less than 0.30% Fe.

For example, the previous composition preferably comprises less than 0.10% Cu.

For example, the AA4004 composition is an aluminum alloy which could be suitable as a brazing alloy according to the present invention. Its composition is, in weight percentages: from 9.00 to 10.50% Si, less than 0.80% Fe, less than 0.25% Cu, less than 0.10% Mn, 1.00 to 2.00% Mg, less than 0.20% Zn, other elements less than 0.05% each and less than 0.15% in total, the remainder being aluminum.

For example, the AA4104 composition is an aluminum alloy which could be suitable as a brazing alloy according to the present invention. Its composition is, in weight percentages: from 9.00 to 10.50% Si, less than 0.80% Fe, less than 0.25% Cu, less than 0.10% Mn, 1.00 to 2.00% Mg, less than 0.20% Zn, 0.02 to 0.20% Bi, other elements less than 0.05% each and less than 0.15% in total, the remainder being aluminum.

### Interlayer Aluminum Alloy

According to one embodiment, the strip or sheet according to the present invention is plated, over one or two face(s) of the core layer, with a so-called interlayer aluminum alloy, preferably of the 1xxx or 3xxx series, placed between the core and the optional brazing alloy, preferably comprising (in weight %):
Si: less than 0.50%, more preferably less than 0.20%;
Fe: less than 0.70%, more preferably less than 0.30%, even more preferably less than 0.20%;
Mn: from 0.30 to 1.40%, more preferably from 0.50 to 0.90%, more preferably from 0.60 to 0.80%, or according to a variant from 1.00 to 1.30%;
Cu: less than 0.30%, preferably less than 0.10%, even more preferably less than 0.05%;
optionally Mg, Zn and/or In;
other elements <0.05% each and <0.15% in total;
remainder aluminum.

Preferably, the interlayer aluminum alloy of the strip or sheet according to the present invention comprises (% by weight): Si<0.15%; Fe<0.20%; Cu<0.10%; Mn from 0.60 to 0.80%; Mg<0.02% according to a first variant or Mg<0.50%, preferably <0.25% according to a second variant; other elements <0.05% each and <0.15% in total, remainder aluminum.

Preferably, the interlayer aluminum alloy is an AA3xxx series alloy.

According to one variant, the interlayer aluminum alloy may further comprise:
Zn according to a content of 1.5 to 2.3%; and/or
In according to a content of 0.005 to 0.04%.

### Strip or Sheet

The strip or sheet according to the present invention is a so-called brazing strip or sheet, which may be used for the manufacture of different portions of a heat exchanger, for example tubes, plates, manifolds, battery cooling systems for electric vehicles, etc.

The strip or sheet according to the present invention may have a configuration with several layers, and in particular with 2, 3, 4 or 5 layers.

The configuration with two layers comprises a core plated over one face only with a covering layer, in particular either with a brazing layer or with a sacrificial anode.

The configuration with three layers comprises:
either a core layer plated over both faces thereof with a brazing layer;
either a core layer plated over both faces thereof with a sacrificial anode;
either a core layer plated over one face with an interlayer, itself plated with a brazing layer;
either a core layer plated over a first face with a brazing layer and over the other face with a sacrificial anode.

The configuration with four layers comprises:
either a core layer plated over a first face with an interlayer, itself plated with a brazing layer, and over the other face with a brazing layer;
or a core layer plated over a first face with an interlayer, itself plated with a brazing layer, and over the other face with a sacrificial anode.

The configuration with five layers comprises a core layer plated over both faces thereof with an interlayer itself plated with a brazing layer.

In each of the aforementioned configurations, when two brazing layers, two interlayers or two sacrificial anodes are provided, then they may be identical or different in terms of composition and thickness. In particular, the thickness of each of the layers other than the core layer, i.e. the brazing layer, the interlayer and the sacrificial anode, is preferably from 4 to 15%, preferably from 4 to 11% of the total thickness of the strip or sheet according to the present invention. Preferably, the composition of the sacrificial anodes is identical.

### Method

Another object of the invention is a method for manufacturing a strip or sheet, comprising the successive steps of:
casting a plate made of a core alloy;
optionally homogenizing the plate at 550 to 630° C., preferably at 580 to 630° C. for 1 to 24 hours;
optionally plating with a covering aluminum alloy over one or two face(s) of the core layer and optionally an interlayer aluminum alloy over one or two face(s) of the core layer;
preheating to a temperature from 450 to 550° C., preferably with maintenance at the maximum temperature for less than 30 hours, preferably for less than 20 hours, preferably for less than 12 hours, more preferably for less than 3 hours;
hot rolling the optionally homogenized and optionally plated plate at a temperature from 420 to 530° C. up to a thickness of 2 to 6 mm,
cold rolling to the desired thickness, the thickness of the strip or sheet after cold rolling preferably being 0.15 to 3 mm, and
annealing at a temperature from 240 to 450° C., preferably from 240 to 400° C., preferably from 280 to 370° C., with maintenance at the maximum temperature for 10 minutes to 15 hours, preferably for 20 minutes to 3 hours.

In particular, said covering alloys of the methods according to the present invention may be a brazing alloy, or a sacrificial anode, or two brazing alloys, or two sacrificial anodes, or a brazing alloy and a sacrificial anode.

Preferably, there is no intermediate annealing in the methods according to the present invention.

When it is intended for parts with significant shaping, the strip or sheet may be used in the annealed state (O state) by proceeding with a final annealing at a temperature from 300 to 450° C., in a continuous furnace or in a batch furnace. In a batch furnace, annealing is preferably done at a temperature from 325 to 400° C., preferably from 330 to 400° C. This annealing improves the formability. In other cases, it may be used in the hardened or restored state, which leads to a better mechanical strength, for example an H14 or H24 state (according to the standard NF EN 515), this last state being obtained by restoration annealing at a temperature from 250 to 325° C., preferably lower than 310° C.

Before installing any plating materials, it is possible to proceed with a homogenization of the core alloy plate at a temperature comprised from 550 to 630° C., preferably from 580 to 630° C. This homogenization is favorable to the ductility of the rolled strip or sheet and it is recommended when the strip or sheet is used in the O state. It promotes the coalescence of the dispersoids with Mn.

### Use

Another object of the invention is a heat exchanger made at least partially from a strip or sheet according to the present invention.

Another object of the invention is the use of a strip or sheet according to the present invention, for the manufacture of a heat exchanger, said strip or sheet having an improved mechanical strength without degradation of the corrosion resistance or of the brazability.

The strips or sheets according to the present invention can be used in the manufacture of brazed heat exchangers, in particular for motor vehicles, such as engine cooling radiators, evaporators, heating radiators and charge air coolers, manifolds, battery coolers of electric vehicles, as well as in air-conditioning systems.

### EXAMPLES

### Example 1

Different core ingots have been cast in vertical semi-continuous casting (DC casting) with aluminum alloys having the compositions reported in Table 2 hereinafter, in weight percentages:

TABLE 2

| Alloys | Si | Fe | Cu | Mn | Ti | T solidus (° C.) |
|---|---|---|---|---|---|---|
| Reference | 0.18 | 0.16 | 0.64 | 1.34 | 0.08 | 638 |
| Comparative-Core-1 | 0.19 | 0.18 | 0.95 | 1.38 | 0.08 | 632 |
| Comparative-Core-2 | 0.19 | 0.18 | 0.97 | 1.67 | 0.08 | 632 |
| Innov-Core-1 | 0.49 | 0.17 | 0.66 | 1.58 | 0.09 | 636 |
| Innov-Core-2 | 0.49 | 0.17 | 0.94 | 1.57 | 0.10 | 631 |

Afterwards, the core ingots have been assembled, on one face, with a braze plating made of an AA4045 type alloy (9.71% Si; 0.2% Fe; <0.05% Cu; <0.05% Mg; <0.05% Mn; <0.05% Sr; 0.02% Ti) which represented 7.5% of the total thickness of the assembly. The assembly has been preheated for 12 hours at 500° C., hot rolled at a temperature of about 490° C., then cold rolled from 4 mm to 0.4 mm. A final annealing for 1 hour at 320° C. has allowed obtaining an H24 metallurgical state.

Afterwards, brazing simulations have been carried out on 21 cm×30 cm samples to replicate the conditions of brazing under controlled atmosphere (CAB) having less than 50 ppm of O₂, with heating at 600° C. for 2 minutes.

Tensile strength measurements at different temperatures (20° C., 110° C. and 130° C.) and corrosion resistance according to the SWAAT test on the plated face have been carried out on the brazed samples.

The tensile strength measurements have been carried out according to the standard ISO 6892-1.

The corrosion resistance has been determined according to the following protocol:
prepare for each configuration a sample with the dimensions 126 mm (L direction)×90 mm (TL direction), previously degreased with a white absorbent paper soaked in acetone;
protect the untested face as well as the four edges over a width of about 0.5 cm with a transparent vinyl adhesive (for example of the 3M vinyl 764 type);
clean the face to be tested with an absorbent paper soaked in acetone;
place the samples thus prepared on a rack with an inclination of about 60° with respect to the horizontal;
carry out for each sample a cyclic SWAAT test (Sea Water Acidified Acetic Test) according to the standard ASTM G85 A3, comprising in particular an alternation of salt spray phases for 30 min and wet phases for 1 h30 at a temperature of 49° C.

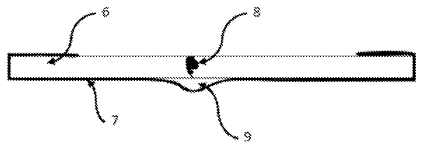

The number of punctures has been recorded every day for each sample throughout the test, i.e. over 13 days. The punctures were visible on the back of each sample as they formed blisters in the adhesive applied over the untested side, as illustrated in FIG. 1. In FIG. 1, reference 6 corresponds to the sample; reference 7 corresponds to the adhesive; reference 8 corresponds to a perforation; reference 9 corresponds to a blister formed by a perforation.

The results of monitoring the number of punctures are reported in Table 3 hereinafter.

TABLE 3

| | Rm after brazing | | | |
|---|---|---|---|---|
| | 400 μm | | | Number of punctures |
| | (MPa) | | | after the SWAAT test |
| Alloys | 20° C. | 110° C. | 130° C. | 13 days |
| Reference | 150 | 150 | 150 | 14 |
| Comparative-Core-1 | 160 | 174 | 166 | 100 |
| Comparative-Core-2 | 169 | 178 | 156 | 74 |
| Innov-Core-1 | 166 | 179 | 171 | 9 |
| Innov-Core-2 | 161 | 167 | 168 | 7 |

In addition to the information given in Table 3 hereinbefore, the corrosion morphology has been determined for each alloy, according to the microscopic observations after the SWAAT test:
Comparative-1: deep pitting;
Comparative-2: deep pitting;
Innov1: better than the reference, because the corrosion depth was lower than that of the reference;
Innov2: better than the reference, because the corrosion depth was lower than that of the reference.

According to Table 3 hereinbefore, it is possible to draw the following conclusions:
the present invention allows obtaining better mechanical strengths than the reference alloy;
the present invention allows obtaining at least the same level of performance in terms of resistance to corrosion and susceptibility to piercing after a SWAAT test as the reference alloy.

### Example 2

Different core ingots have been cast in vertical semi-continuous casting (DC casting) with aluminum alloys having the compositions reported in Table 4 hereinafter, in weight percentages:

TABLE 4

| Alloys | Si | Fe | Cu | Mn | Ti | T solidus (° C.) |
|---|---|---|---|---|---|---|
| Comparative-Core-3 | 0.2 | 0.13 | 0.64 | 1.33 | 0.08 | 638 |
| Comparative-Core-4 | 0.19 | 0.12 | 0.62 | 1.28 | 0.08 | 638 |
| Comparative-Core-5 | 0.18 | 0.12 | 0.93 | 1.52 | 0.08 | 634 |
| Innov-Core-3 | 0.45 | 0.15 | 0.93 | 1.52 | 0.08 | 632 |

The core ingots have been homogenized at a temperature of 550 to 630° C. for 1 to 24 hours.

Afterwards, the core ingots have been assembled with a brazing plating made of an AA4045 type alloy on one side, which represented 5% of the total thickness of the assembly, and with a sacrificial anode made of an AA7072 type alloy on the other side, which represented 10% of the total thickness of the assembly. The compositions of the brazing alloys and of the sacrificial anodes are reported in Table 5 hereinafter, in weight percentages.

TABLE 5

| Alloys | Si | Fe | Cu | Mn | Ti | Zn |
|---|---|---|---|---|---|---|
| Brazing-1 | 9.83 | 0.13 | 0.01 | 0.01 | 0.02 | 0.003 |
| Brazing-2 | 9.73 | 0.19 | 0.01 | 0.02 | 0.03 | 0.003 |
| Brazing-3 | 9.73 | 0.19 | 0.01 | 0.02 | 0.03 | 0.003 |
| Brazing-4 | 9.73 | 0.19 | 0.01 | 0.02 | 0.03 | 0.003 |
| Anode-1 | 0.14 | 0.32 | 0.001 | 0.003 | 0.03 | 0.97 |
| Anode-2 | 0.15 | 0.33 | 0.001 | 0.003 | 0.03 | 0.98 |
| Anode-3 | 0.15 | 0.33 | 0.001 | 0.003 | 0.03 | 0.98 |
| Anode-4 | 0.15 | 0.33 | 0.001 | 0.003 | 0.03 | 0.98 |

The brazing alloy and the sacrificial anode #1have been plated over the core Comparative-Core-3 (Assembly-1). The brazing alloy and the sacrificial anode #2 have been plated over the core Comparative-Core-4 (Assembly-2). The brazing alloy and the sacrificial anode #3 have been plated over the core Comparative-Core-5 (Assembly-3). The brazing alloy and the sacrificial anode #4 have been plated over the core Innov-Core-3 (Assembly-4).

The assemblies have been preheated at a temperature of 450 to 550° C., with maintenance at the maximum temperature for less than 30 hours, hot rolled at a temperature of about 500° C. to a 3 mm thickness, then cold rolled to a total final thickness for the sandwich of 1 mm. A final annealing for 30 minutes at 340° C. has allowed obtaining a metallurgical state O.

Afterwards, brazing simulations have been carried out on 21 cm×30 cm samples to replicate the conditions of brazing under controlled atmosphere (CAB) having less than 50 ppm of O₂, with heating at 600° C. for 2 minutes.

The tensile strength UTS(=Rm), yield strength TYS(=Rp_{0,2}) and elongation E % (=A %) measurements have been carried out on the samples before and after brazing. Corrosion resistance measurements according to the SWAAT test on the face plated with the brazing alloy AA4045 have been carried out on the brazed samples.

The tensile strength UTS(=Rm), yield strength TYS(=Rp_{0,2}) and elongation E % (=A %) measurements have been carried out according to the standard ISO 6892-1.

The results of the mechanical performance measurements before and after brazing are reported in Table 6 hereinafter.

TABLE 6

| | |
|---|---|
| Before brazing | After brazing |

| Assembly | TYS | UTS | E % | TYS | UTS | E % |
|---|---|---|---|---|---|---|
| 1 | 53 | 135 | 26.7 | 47 | 136 | 28.2 |
| 2 | 50 | 135 | 28.6 | 46 | 135 | 27.3 |
| 3 | 57 | 150 | 30.4 | 52 | 152 | 24.7 |
| 4 | 53 | 145 | 25.5 | 51 | 150 | 25.4 |

The corrosion resistance has been determined according to the following protocol:
prepare for each configuration a sample with the dimensions 126 mm (L direction)×90 mm (TL direction), previously degreased with a white absorbent paper soaked in acetone;
protect the untested face as well as the four edges over a width of about 0.5 cm with a transparent vinyl adhesive (for example of the 3M vinyl 764 type);
clean the face to be tested with an absorbent paper soaked in acetone;
place the samples thus prepared on a rack with an inclination of about 60° with respect to the horizontal;
carry out for each sample a cyclic SWAAT test (Sea Water Acidified Acetic Test) according to the standard ASTM G85 A3, comprising in particular an alternation of salt spray phases for 30 min and wet phases for 1 h30 at a temperature of 49° C.

In parallel, the number of punctures has been recorded every day for each sample throughout the duration of the SWAAT test, i.e. 29 days, 41 days, 58 days and 63 days. The punctures were visible on the back of each sample as they formed blisters in the adhesive applied over the untested face, as illustrated in FIG. 1.

The results of monitoring the number of punctures are reported in Table 7 hereinafter.

TABLE 7

Number of punctures after the SWAAT test

| Assembly | 29 days | 41 days | 58 days | 63 days |
|---|---|---|---|---|
| 1 | 6 | 4 | 27 | 131 |
| 2 | 0 | 1 | 6 | 55 |
| 3 | 0 | 16 | 48 | 113 |
| 4 | 0 | 0 | 0 | 0 |

According to Tables 6 and 7 hereinbefore, it is possible to draw the conclusion that the present invention allows obtaining the best trade-off between satisfactory mechanical strengths, in particular Rm (=UTS) higher than 140 MPa, and an improved corrosion resistance, for example absence of punctures due to corrosion for a longer period.

1. A strip or sheet, intended for manufacture of brazed heat exchangers, having a core layer, optionally a covering layer on one or two face(s) of the core layer and optionally an interlayer on one or two face(s) of the core layer placed between the core layer and the optional covering layer, the core layer being made of an aluminum alloy with the following composition (% by weight):
Si: more than 0.25%, optionally more than 0.30%, optionally more than 0.35%, optionally more than 0.40%; and less than 0.70%, optionally less than 0.65%, optionally less than 0.60%, optionally less than 0.55%;
Fe: less than 0.25%, optionally less than 0.20%; and at least 0.08%, optionally more than 0.10%;
Cu: more than 0.60%, optionally more than 0.70%, optionally more than 0.80%, optionally more than 0.85%; and less than 1.10%, optionally less than 1.00%, optionally less than 0.95%;
Mn: more than 1.40%, optionally more than 1.50%; and less than 2.00%, optionally less than 1.80%, optionally less than 1.65%; —Ti: less than 0.15%, optionally less than 0.12%, optionally less than 0.10%; and more than 0.05%;
Mg: less than 0.05%, optionally less than 0.02%, optionally less than 0.01%, optionally less than 0.001%;
Zr: less than 0.01%, optionally less than 0.005%;
Cr: less than 0.01%, optionally less than 0.005%;
Zn: less than 0.20%, optionally less than 0.10%, optionally less than 0.05%, optionally less than 0.01%;
impurities: less than 0.05% each and less than 0.15% in total;
remainder aluminum.

2. The strip or sheet according to claim 1, wherein said strip or sheet is plated, over one or two face(s) of the core layer and/or over a free face of the optional interlayer, with a covering alloy which is a brazing aluminum alloy, optionally a 4xxx series alloy comprising from 4.00 to 13.00% by weight of Si, less than 1.00% by weight of Fe, and optionally less than 0.20%, optionally less than 0.10%, optionally less than 0.05%, optionally less than 0.02% Zn.

3. The strip or sheet according to claim 2, wherein the 4xxx series brazing aluminum alloy comprises (% by weight):
Si: from 5.00 to 13.00%, optionally from 6.00 to 11.00%, optionally from 7.50 to 10.50;
Fe: less than 0.60%, optionally less than 0.50%, optionally less than 0.30%;
Cu: less than 0.40%, optionally less than 0.10%, optionally less than 0.05%;
Mn: less than 0.20%, optionally less than 0.10%, optionally less than 0.05%;
Mg: according to a first variant less than 0.20%, optionally less than 0.10%, optionally less than 0.05%; or according to a second variant from 0.50 to 2.50%, optionally from 1.00 to 2.00%;
Zn: less than 0.20%, optionally less than 0.10%, optionally less than 0.05%, optionally less than 0.02%;
Ti: less than 0.30%, optionally less than 0.10%, optionally less than 0.05%; —optionally Bi, Y, Sr and/or Sn; —other elements: less than 0.05% each and less than 0.15% in total;
remainder aluminum.

4. The strip or sheet according to claim 1, wherein said strip or sheet is plated, over one or two face(s) of the core layer, with a covering alloy of the sacrificial anode type, which is optionally a 7xxx series alloy, optionally having the following composition, in weight percentages:
less than 0.50% Si;
less than 0.50% Fe;
less than 0.25% Cu;
less than 0.30% Mn;
less than 0.20%, optionally less than 0.15% Mg;
from 0.70 to 5.00%, optionally from 0.70 to less than 2.50%, optionally from 0.70 to less than 1.30%, optionally from 0.70 to less than 1.00% Zn; —less than 0.15% Ti;
other elements less than 0.05% each and less than 0.15% in total;
remainder aluminum.

5. The strip or sheet according to claim 1, wherein said strip or sheet is plated, over one or two face(s) of the core layer, with a covering alloy of the sacrificial anode type, which is optionally a 3xxx series alloy, optionally having the following composition, in weight percentages:
from 0.10 to 0.35% Si;
less than 0.70% Fe;
less than 0.20% Cu;
from 0.70 to 2.00%, optionally from 0.90 to 1.30% Mn;
from 0.50 to 1.60%, optionally from 0.90 to 1.20% Zn;
less than 0.15% Ti;
other elements less than 0.05% each and less than 0.15% in total;
remainder aluminum.

6. The strip or sheet according to claim 2, wherein said strip or sheet is plated, over one or two face(s) of the core layer, with a so-called interlayer aluminum alloy, optionally of the 1xxx or 3xxx series, placed between the core and the brazing alloy, optionally comprising (in weight percentages):
Si: less than 0.50%, optionally less than 0.20%;
Fe: less than 0.70%, optionally less than 0.30%, optionally less than 0.20%;
Mn: from 0.30 to 1.40%, optionally from 0.50 to 0.90%, optionally from 0.60 to 0.80%; or according to one variant from 1.00 to 1.30%;
Cu: less than 0.30%, optionally less than 0.10%, optionally less than 0.05%;
optionally Mg, Zn and/or In;
other elements <0.05% each and <0.15% in total;
remainder aluminum.

7. The strip or sheet according to claim 6, wherein the interlayer aluminum alloy comprises (% by weight):
Si<0.15%;
Fe<0.20%;
Cu<0.10%;
Mn from 0.60 to 0.80%;
Mg<0.02% according to a first variant or Mg<0.50%, optionally <0.25% according to a second variant;
other elements <0.05% each and <0.15% in total,
remainder aluminum.

8. A method for manufacturing a strip or sheet according to claim 1, comprising successively:
casting a plate made of a core alloy;
optionally homogenizing the plate at 550 to 630° C., optionally at 580 to 630° C. for 1 to 24 hours;
optionally plating with a covering aluminum alloy over one or two face(s) of the core layer and optionally an interlayer aluminum alloy over one or two face(s) of the core layer;
preheating to a temperature from 450 to 550° C., optionally with maintenance at the maximum temperature for less than 30 hours, optionally for less than 20 hours, optionally for less than 12 hours, optionally for less than 3 hours;
hot rolling the optionally homogenized and optionally plated plate at a temperature from 420 to 530° C. up to a thickness of 2 to 6 mm,
cold rolling to the desired thickness, the thickness of the strip or sheet after cold rolling optionally being 0.15 to 3 mm, and
annealing at a temperature from 240 to 450° C., optionally from 240 to 400° C., optionally from 280 to 370° C., with maintenance at maximum temperature for 10 minutes to 15 hours, optionally for 20 minutes to 3 hours.

9. A heat exchanger made at least partially from a strip or sheet according to claim 1.

10. A product comprising a strip or sheet according to claim 1, for manufacture of a heat exchanger, said strip or sheet having an improved mechanical strength without degradation of corrosion resistance or of brazability.
